(19) United States
(12) Patent Application Publication
(10) Pub. No.: US 2006/0227584 A1
(43) Pub. Date: Oct. 12, 2006

(54) Zero-voltage-switching electric converter

(76) Inventor: Kan-Sheng Kuan, Hsinchu (TW)

Correspondence Address: John S. Egbert;Harrison & Egbert, 7th Floor, 412 Main Street, Houston, TX, 77002, US

(21) Appl. No.: 11/103,859

(22) Filed: Apr. 12, 2005

(51) Int. Cl. H02M 7/5387

(52) U.S. Cl. 363/132

(57) ABSTRACT

The present zero-voltage-switching electric converter has a power source, an inverter electrically connected to the power source and a resonant load electrically connected to the power source and the inverter. The resonant load includes a first capacitor, a first inductor connected in series to the first capacitor and a load coupled to the first capacitor. The resonant load can further include a second inductor connected in parallel to the first capacitor and a third inductor connected in series to the load. In addition, the resonant load can further include a transformer including a primary winding connected in parallel to the first capacitor, and a secondary winding connected in parallel to the load. The inverter can be a synchronized boost inverter, a half bridge boost inverter, or a full bridge boost inverter.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to an electric converter, and more particularly, to a zero-voltage-switching electric converter.

### BACKGROUND OF THE INVENTION

In applications, electronic power converter may have a variety of input and output. Input may be a DC power source such as battery, solar cell or other DC power supply. It may also be AC power source from a power line, in which, first of all, the 50 Hz/60 Hz line-voltage is rectified into a DC voltage. With a simple rectification, the DC voltage has ripple with peak voltage of V_{dc}=Vᵣₘₛ√, and a large input current spike exists near the peak. This spike current causes bad effect on power generation and distribution. So it is an increasing demand that the input current should be proportional to the voltage. Therefore, the input current should be actively shaped, so called power factor correction (PFC), while the output power is regulated. Two control variables are needed to achieve this demand. The standard method goes through a two-stage process, the first stage is input current shaping and the second stage is power conversion.

U.S. Pat. No. 6,819,575 discloses a PFC “flyboost” cell, with a transformer having primary winding connected to input power and secondary winding connected to an output rectifier, which has both functions of a flyback transformer and boost inductor. U.S. Pat. No. 5,959,849 discloses a single-stage PFC with output electrical isolation, wherein the converter has a configuration of combining a boost circuit and a forward circuit in one power stage. U.S. Pat. No. 6,490,177 discloses DC power converter consisting of a series-resonant branch used to transform a DC voltage source into a DC current source exhibiting, a uni-polar, zero-current-switching characteristic. U.S. Pat. No. 6,115,267 discloses a transformer isolated, PFC AC-DC power converter comprising a main power path which is buck derived, and most of the power passes through a single power stage to the output. U.S. Pat. No. 6,118,673 discloses a single-stage switched AC/DC converter with a PFC lead enhanced by inclusion of a saturable reactor and/or by connecting the PFC lead to an intermediate tap in a primary winding of the customary isolation transformer located in the DC/DC conversion part of the converter. U.S. Pat. No. 6,483,721 discloses a resonant power converter includes a DC power source, a pair of MOS-FETs connected in series to the DC power source, a transformer (Tr) arranged at the subsequent stage of the MOS-FETs. The transformer (Tr) includes a primary coil and a secondary coil, a capacitor (C4) is arranged in parallel with the secondary coil of the transformer (Tr) so that series resonance occurs between the leakage inductance of the transformer (Tr) and the capacitor (C4).

### BRIEF SUMMARY OF THE INVENTION

The objective of the present invention is to provide a zero-voltage-switching electric converter.

In order to achieve the above-mentioned objective and avoid the problems of the prior skills, the present invention provides a zero-voltage-switching electrical converter. The zero-voltage-switching electric converter comprises a power source, an inverter electrically connected to the power source and a resonant load electrically connected to the power source and the inverter. The resonant load includes a first capacitor, a first inductor connected in series to the first capacitor and a load coupled to the first capacitor. The resonant load can further comprise a second inductor connected in parallel to the first capacitor and a third inductor connected in series to the load. In addition, the resonant load can further comprise a transformer including a primary winding connected in parallel to the first capacitor, and a secondary winding connected in parallel to the load. The resonant load may further comprise a first rectifier connected to the load, and the transformer may comprise a primary winding connected in parallel to the first capacitor and a secondary winding connected to the first rectifier.

One example of the inverter is a synchronized boost inverter, which comprises a switch-pair including an upper switch and a lower switch connected in series to the upper switch, an energy bank capacitor connected in parallel to the switch-pair, wherein the resonant load is connected to a junction between the upper switch and the lower switch, and the power source is connected to a junction between the lower switch and the energy bank capacitor.

Another example of the inverter is a half bridge boost inverter, which comprises a switch-pair including an upper switch and a lower switch connected in series to the upper switch, a capacitor-pair connected in parallel to the switch-pair. The capacitor-pair includes an upper capacitor and a lower capacitor connected in series to the upper capacitor, the resonant load is connected to a junction between the upper switch and the lower switch, and the power source is connected to a junction between the upper capacitor and the lower capacitor.

A further example of the inverter is a full bridge boost inverter, which comprises two switch-pairs connected in parallel and an energy bank capacitor connected in parallel to the switch-pair. Each switch pair includes an upper switch and a lower switch connected in series to the upper switch, the resonant load is connected to a junction between the upper switch and the lower switch of one switch-pair, and the power source is connected to a junction between the upper switch and the lower switch of another switch-pair.

The zero-voltage-switching electric converter can comprise a switch controller including a first controlling unit for generating an amplitude demand from a difference between a target voltage and the voltage of the energy bank capacitor, a multiplier for generating an instantaneous target current demand from the amplitude demand and the voltage of first capacitor, a second controlling unit for generating a duty demand from the instantaneous target current demand and the current of the energy bank capacitor, a third controlling unit for generating a feedback signal from a difference between a target voltage and the voltage applied to the load, a voltage-controlled oscillator for generating a resonance frequency from the feedback signal, and a comparator for generating a switching signal for the inverter.

### BRIEF DESCRIPTION OF THE SEVERAL VIEWS OF THE DRAWINGS

The objectives and advantages of the present invention will become apparent upon reading the following description and upon reference to the accompanying drawings in which:

FIG. 1 is a circuit diagram showing the circuit configuration of a zero-voltage-switching electrical converter according to the first embodiment of the present invention.

FIGS. 2(a) to (c) illustrate some circuit configurations of the transformer;

FIG. 3 is a circuit diagram showing the circuit configuration of a zero-voltage-switching electrical converter according to the second embodiment of the present invention.

FIG. 4 is a circuit diagram showing the circuit configuration of a zero-voltage-switching electrical converter according to the third embodiment of the present invention.

FIG. 5 is a circuit diagram showing the circuit configuration of a zero-voltage-switching electrical converter according to the fourth embodiment of the present invention.

FIG. 6 is a circuit diagram showing the circuit configuration of a zero-voltage-switching electrical converter according to the fifth embodiment of the present invention.

FIG. 7 is a functional block diagram of a switch controller for the zero-voltage-switching electrical converter shown in FIG. 6; and

FIG. 8 is a diagram showing the relationship between the amplitude and the resonant frequency.

### DETAILED DESCRIPTION OF THE INVENTION

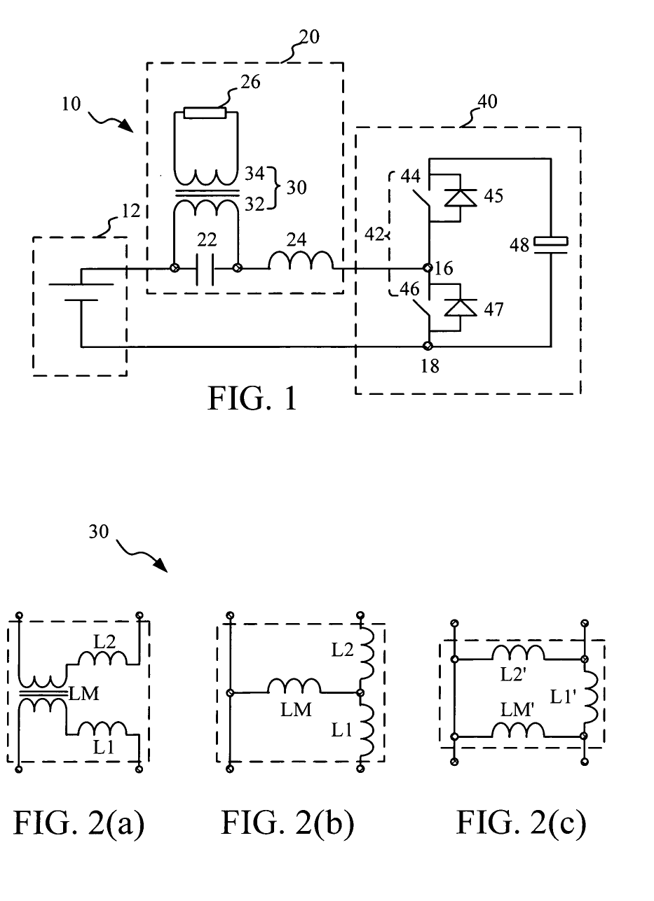

FIG. 1 is a circuit diagram showing the circuit configuration of a zero-voltage-switching electrical converter 10 according to the first embodiment of the present invention. The zero-voltage-switching electric converter 10 comprises a DC power source 12, a synchronized boost inverter 40 electrically connected to the DC power source 12, and a resonant load 20 electrically connected to the power source 12 and the synchronized boost inverter 40. The resonant load 20 includes a first capacitor 22, a first inductor 24 connected in series to the first capacitor 22, a load 26 such as a backlight CCFL (cold cathode fluorescent lamp) coupled to the first capacitor 22 via a transformer 30. The transformer 30 includes a primary winding 32 connected in parallel to the first capacitor 22 and a secondary winding 34 connected in parallel to the load 26.

The synchronized boost inverter 40 comprises a switch-pair 42 including an upper switch 44 and a lower switch 46 connected in series to the upper switch 44, two parasitic diodes 45, 47, and an energy bank capacitor 48 connected in parallel to the switch-pair 42. The resonant load 20 is connected to a junction 16 between the upper switch 44 and the lower switch 46, and the power source 12 is connected to a junction 18 between the lower switch 46 and the energy bank capacitor 48. The transformer 30 extracts power from the first capacitor (resonance capacitor) 22 to the load 26. In addition, the primary winding 32 also provides a low frequency current path to charge the energy bank capacitor 48, so the primary winding 32, in series with the first inductor (the resonance inductor) 24, also functions as the boost inductor. The high-frequency ripple is actually transferred via the secondary winding 34 to the load 26.

FIGS. 2(a) to 2(c) illustrate some circuit configurations of the transformer 30. LM represents the mutual inductance, and L1 and L2 represent the leakage inductance. The transformer 30 may be viewed as composite of LM, L1 and L2 equivalent circuit, and the T-inductor circuit shown in FIG. 2(b) may be viewed as equivalent p-inductor circuit compared with the mutual inductance LM′ and the leakage inductance L1′ and L2′ as shown in FIG. 2(c). LM normally is larger compared with the inductance of the first inductor 24 and L1 and L2, so it may be neglected. Parasitic capacitance is smaller compared with the capacitance of the first capacitor 22, so it may also be neglected. The resonance characteristic should be analyzed in two modes, without (i.e., open state) and with load.

For discharge or florescent lamp load, before it is lit on, the impedance is so high that it may be viewed as open. The circuit oscillates as perfect resonator. But, once the lamp load is lit on, it becomes resistive. So, the load resistance is in series with leakage inductance, which in turn is parallel with the first capacitor 22. The circuit is deemed a resistor inductor series. For rectifying load, the impedance is different at voltage below and above a rectified output capacitor voltage. Below that voltage, the rectifying diode is not conductive, so it seems to be open. Above that voltage, the rectifying diode is conductive, so it seems to be short. Since the output capacitor is usually very large, the voltage of the first capacitor 22 looks like open load resonance, but at the peak is a plateau superposed with another resonance of higher frequency.

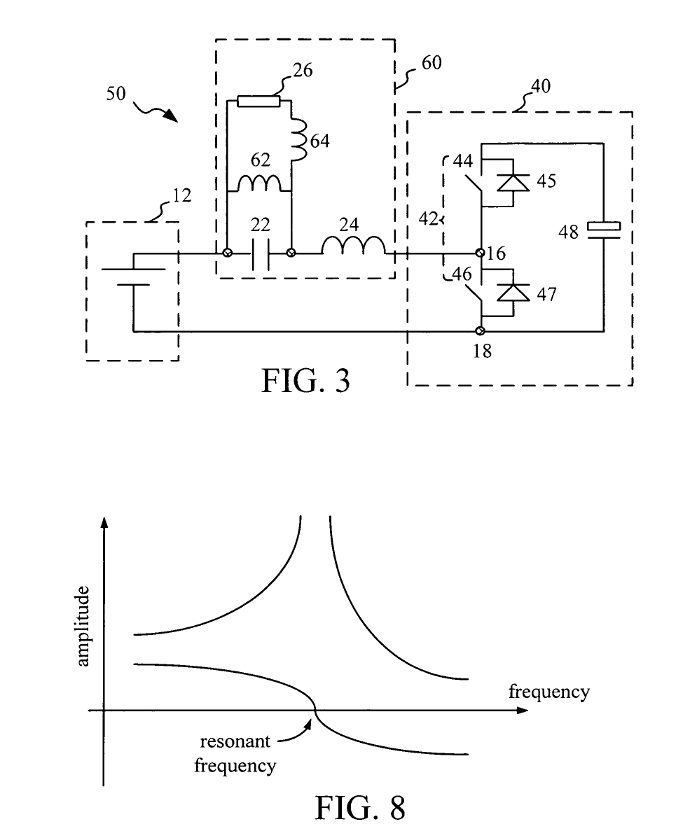

FIG. 3 is a circuit diagram showing the circuit configuration of a zero-voltage-switching electrical converter 50 according to the second embodiment of the present invention. In comparison with the zero-voltage-switching electrical converter 10 shown in FIG. 1, the zero-voltage-switching electrical converter 50 shown in FIG. 3 has a different resonant load 60. The resonant load 60 comprises a second inductor 62 connected in parallel to the first capacitor 22 and a third inductor 64 connected in series to the load 26. Particularly, the load 26 is coupled to the first capacitor 22 via the second inductor 62 together with the third inductor 64, rather than via the transformer 30.

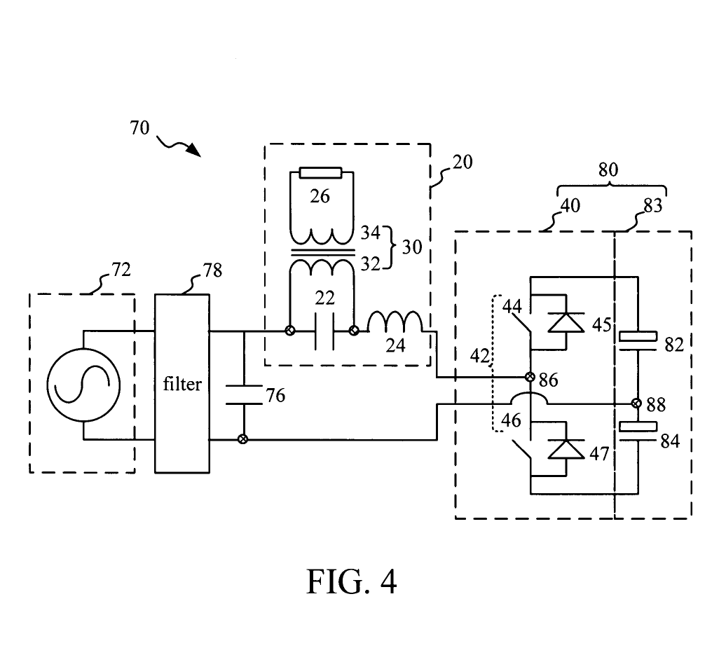

FIG. 4 is a circuit diagram showing the circuit configuration of a zero-voltage-switching electrical converter 70 according to the third embodiment of the present invention. The zero-voltage-switching electrical converter 70 comprises an AC power source 72 and a third capacitor 76 connected in parallel to the AC power source via a filter 78. In addition, the zero-voltage-switching electrical converter 70 uses a half bridge boost inverter 80 rather than the synchronized boost inverter 40 in comparison with the zero-voltage-switching electrical converter 10 shown in FIG. 1. The half bridge boost inverter 80 comprises a capacitor-pair 83 connected in parallel to the switch-pair 42 The capacitor-pair 83 includes an upper capacitor 82 and a lower capacitor 84 connected in series to the upper capacitor 82, the resonant load 20 is connected to a junction 86 between the upper switch 44 and the lower switch 46, and the AC power source 72 is connected to a junction 88 between the upper capacitor 82 and the lower capacitor 84.

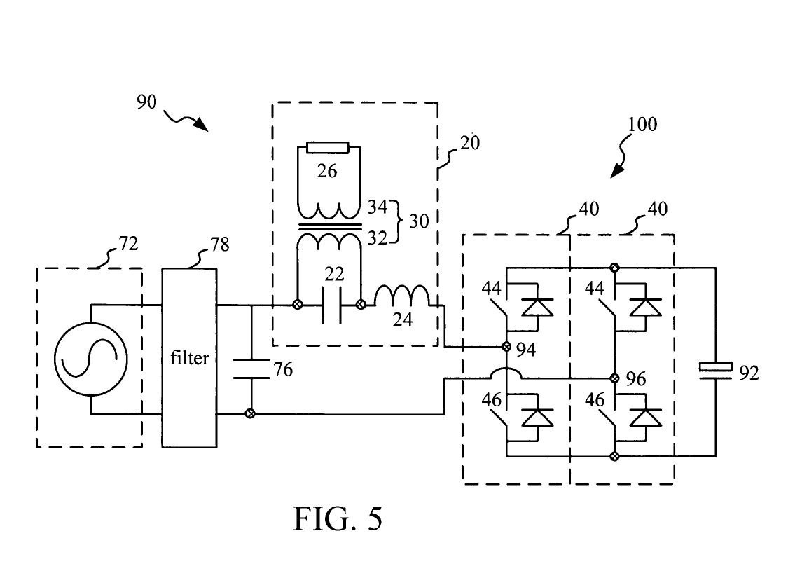

FIG. 5 is a circuit diagram showing the circuit configuration of a zero-voltage-switching electrical converter 90 according to the fourth embodiment of the present invention. In comparison with the zero-voltage-switching electrical converter 70 shown in FIG. 4, the zero-voltage-switching electrical converter 90 shown in FIG. 5 uses a full bridge boost inverter 100 rather the half bridge boost inverter 80 shown in FIG. 4. The full bridge boost inverter 100 comprises two switch-pairs 40 connected in parallel and an energy bank capacitor 92 connected in parallel to the switch-pair 40. The resonant load 20 is connected to a junction 94 between the upper switch 44 and the lower switch 46 of one switch-pair 40, and the AC power source 72 is connected to a junction 96 between the upper switch 44 and the lower switch 46 of another switch pair 40.

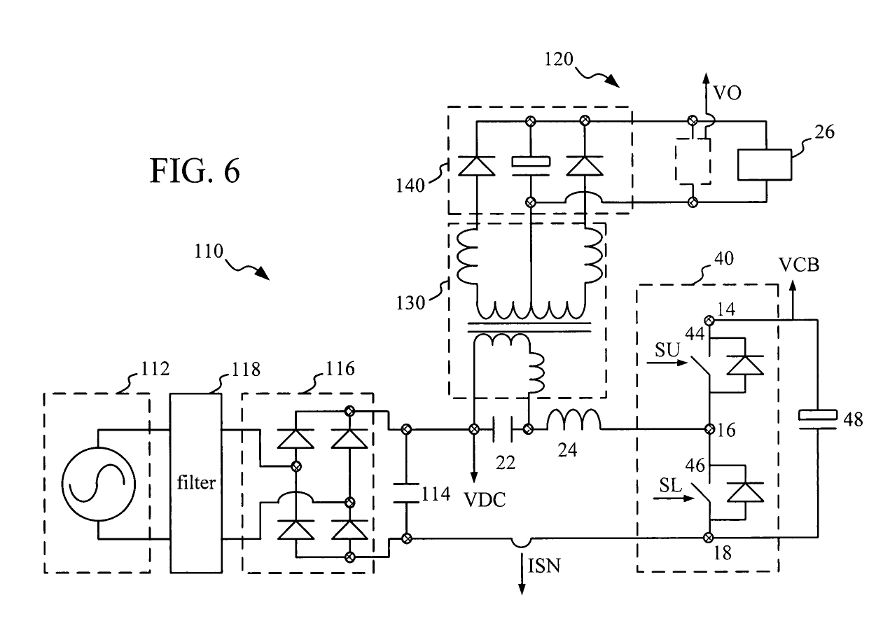

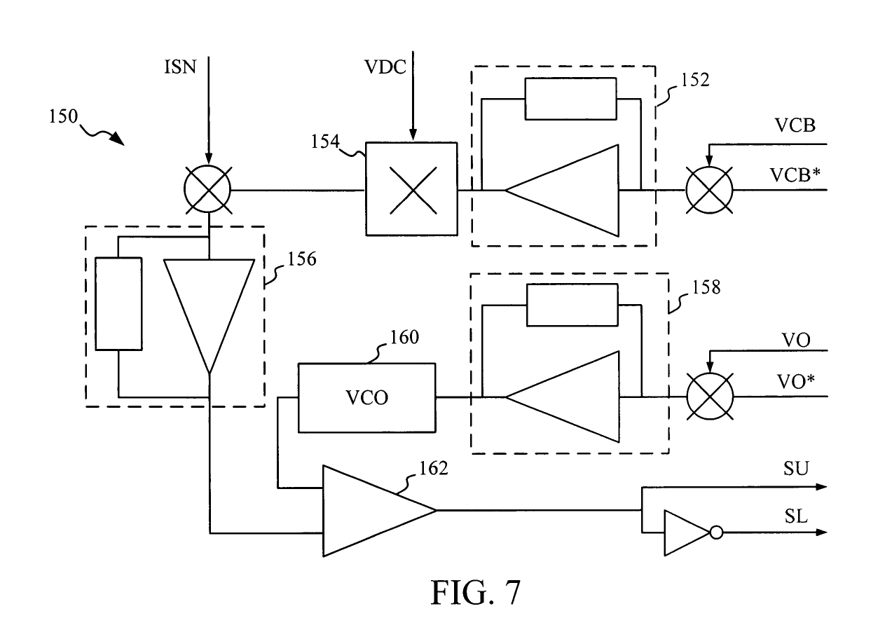

FIG. 6 is a circuit diagram showing the circuit configuration of a zero-voltage-switching electrical converter 110 according to the fifth embodiment of the present invention, and FIG. 7 is a functional block diagram of a switch controller 150 for the zero-voltage-switching electrical converter 110. In comparison with the zero-voltage-switching electrical converter 10 shown in FIG. 1, the zero-voltage-switching electrical converter 110 uses an AC power source 112, and further comprises a capacitor 114 connected to the AC power source 112 via a rectifier 116 and a filter 118. In addition, the resonant load 120 uses a center-tapped transformer 130, and the load 26 is connected to the center-tapped transformer 130 via a rectifier 140.

Referring to FIG. 7, the switch controller 150 comprises a first controlling unit 152 for generating an amplitude demand from a difference between a target voltage (VCB*) and the real voltage (VCB) applied to the energy bank capacitor 48, a multiplier 154 for generating an instantaneous target current demand from the amplitude demand and the voltage (VDC) of the first capacitor 22, a second controlling unit 156 for generating a duty demand from the instantaneous target current demand and the current (ISN) of the inverter 40, a third controlling unit 158 for generating a feedback (FB) signal from a difference between a target voltage (VO*) and the real voltage (VO) applied to the load 26, a voltage-controlled oscillator (VCO) 160 for generating a switching frequency from the feedback signal, and a comparator 162 for generating a switching signal for the synchronized boost inverter 40.

FIG. 8 is a diagram showing the relationship between the amplitude and the resonant frequency. To achieve zero-voltage switching, the current should follow voltage, i.e., inductor-like, so the inverter should operate at a switching frequency higher than the resonance frequency. The switching frequency may be used for power controlling mean, at light load the switching frequency is above the resonance frequency. The operating switching frequency decreases toward the resonance frequency as the load increases.

Referring back to FIG. 6, the voltages of the conjunction 14, 16 and 18 are designated as V_{P}, V_{R} and V_{N}, respectively. The upper switch 44 and the lower switch 46 are never simultaneously on since it will be short circuit. If one is on, the other must be off. However, they may be both off. When the upper switch 44 is on, the output voltage V_{R} is V_{P}; when the lower switch 46 is on, the output voltage V_{R} is V_{N}. If both switches are off, the output voltage V_{R} depends on the current. When current flows into the conjunction 16, it will turn the upper switch 44 on, and the voltage is V_{P}. When current flows away from the conjunction 18, it will turn the lower switch 46 on, and the voltage is V_{N}. When no current flows, the conjunction 46 is float. The time duration of V_{R} being V_{P} is called t₁, the time duration of V_{R} being V_{N} is called t₀, the sum of t₁ and t₀ is a cycle period called t_{S}. t₁ divided by t_{S} is called duty (D). When switches are quickly turned on and off repeatedly, V_{R} becomes a high frequency square wave between V_{P} and V_{N}. This voltage may be filtered to be a smooth voltage. This average voltage can be represented as (V)=D·V_{PN}, with respect to V_{N}.

In the case where the voltage across the switch is not zero and the opposite diode is conducting while the switch is turned on, a large inrush current will pass through the switch, due to diode reverse recovery and parasitic capacitor discharge. It causes switching loss and electromagnetic disturbance (EMI). As for the other zero-voltage-switching techniques, the present invention allows the switch's voltage swings naturally to zero before the switch is turned on, so inrush current is avoided, EMI is reduced, and efficiency is increased tremendously. The zero-voltage-switching may easily be achieved as long as the load is inductance-like. However, this invention uses resonance circuit, so the output power is easily controlled, and it has a wide control range. The zero-voltage-switching is maintained as long as it operates at switching frequency above the resonance frequency, since the resonance circuit behaves as an inductor in that frequency range.

The above-described embodiments of the present invention are intended to be illustrative only. Numerous alternative embodiments may be devised by those skilled in the art without departing from the scope of the following claims.

1. A zero-voltage-switching electric converter, comprising:
a power source;
an inverter electrically connected to the power source; and
a resonant load electrically connected to the power source and the inverter, wherein the resonant load comprises a first capacitor, a first inductor connected in series to the first capacitor and a load coupling to the first capacitor.

2. The zero-voltage-switching electric converter of claim 1, wherein the resonant load further comprises a second inductor connected in parallel to the first capacitor and a third inductor connected in series to the load.

3. The zero-voltage-switching electric converter of claim 1, wherein the resonant load further comprises a transformer connected in parallel to the first capacitor.

4. The zero-voltage-switching electric converter of claim 1, wherein the resonant load further comprises a second capacitor connected in parallel to the load.

5. The zero-voltage-switching electric converter of claim 3, wherein the transformer comprises:
a primary winding connected in parallel to the first capacitor; and
a secondary winding connected in parallel to the load.

6. The zero-voltage-switching electric converter of claim 3, wherein the transformer comprises:
a primary winding connected to the power source and the inverter; and
a secondary winding connected to the first capacitor in parallel.

7. The zero-voltage-switching electric converter of claim 3, wherein the resonant load further comprises a first rectifier connected to the load, and the transformer comprises a primary winding connected in parallel to the first capacitor and a secondary winding connected to the first rectifier.

8. The zero-voltage-switching electric converter of claim 1, wherein the inverter comprises:
a switch-pair comprising an upper switch and a lower switch connected in series to the upper switch; and
an energy bank capacitor connected in parallel to the switch-pair;
wherein the resonant load is connected to a junction between the upper switch and the lower switch, and the power source is connected to a junction between the lower switch and the energy bank capacitor.

9. The zero-voltage-switching electric converter of claim 1, wherein the inverter comprises:
a switch-pair comprising an upper switch and a lower switch connected in series to the upper switch; and
a capacitor-pair connected in parallel to the switch-pair, the capacitor-pair comprising an upper capacitor and a lower capacitor connected in series to the upper capacitor;
wherein the resonant load is connected to a junction between the upper switch and the lower switch, and the power source is connected to a junction between the upper capacitor and the lower capacitor.

10. The zero-voltage-switching electric converter of claim 1, wherein the inverter comprises:
two switch-pairs connected in parallel, each switch pair comprising an upper switch and a lower switch connected in series to the upper switch; and
an energy bank capacitor connected in parallel to the switch-pair;
wherein the resonant load is connected to a junction between the upper switch and the lower switch of one switch-pair, and the power source is connected to a junction between the upper switch and the lower switch of the other switch pair.

11. The zero-voltage-switching electric converter of claim 1, further comprising a third capacitor connected in parallel to the power source via a filter.

12. The zero-voltage-switching electric converter of claim 11, further comprising second rectifier connected in parallel to the third capacitor.

13. The zero-voltage-switching electric converter of claim 1, further comprising a switch controller comprising:
a first controlling unit for generating an amplitude demand from a difference between a target voltage and the voltage of the energy bank capacitor;
a multiplier for generating an instantaneous target current demand from the amplitude demand and the voltage of first capacitor;
a second controlling unit for generating a duty demand from the instantaneous target current demand and the current of the energy bank capacitor;
a third controlling unit for generating a feedback signal from a difference between a target voltage and the voltage applied to the load;
a voltage-controlled oscillator for generating a switching frequency from the feedback signal; and
a comparator for generating a switching signal for the inverter.
